(19) United States
(12) Patent Application Publication
(10) Pub. No.: US 2025/0239263 A1
(43) Pub. Date: Jul. 24, 2025

(54) METHOD AND APPARATUS FOR EXPANDING BANDWIDTH USING ARTIFICIAL INTELLIGENCE

(71) Applicant: IUCF-HYU (INDUSTRY-UNIVERRSITY COOPERATION FOUNDATION HANYANG UNIVERSITY), Seoul (KR)

(72) Inventors: JoonHyuk CHANG, Seoul (KR); DongHyun KIM, Seoul (KR); YunGyeo KIM, Seoul (KR)

(73) Assignee: IUCF-HYU (INDUSTRY-UNIVERRSITY COOPERATION FOUNDATION HANYANG UNIVERSITY), Seoul (KR)

(21) Appl. No.: 19/028,096

(22) Filed: Jan. 17, 2025

(30) Foreign Application Priority Data
Jan. 24, 2024 (KR) 10-2024-0010765

(51) Int. Cl. G10L 19/002

(52) U.S. Cl. CPC G10L 19/002

(57) ABSTRACT

A method performed by an electronic device using artificial intelligence according to an embodiment of the disclosure, the method may include receiving a first narrowband signal and outputting a wideband signal by using the first narrowband signal as input in a pre-trained first artificial intelligence algorithm model.

### CROSS-REFERENCE TO RELATED APPLICATIONS

This application claims the benefits of Korean Patent Application No. 10-2024-0010765, filed on Jan. 24, 2024, in the Korean Intellectual Property Office, the disclosures of which are incorporated herein in their entireties by reference.

### BACKGROUND

### 1. Field

The disclosure relates to a method and an apparatus for extending bandwidth using artificial intelligence.

### 2. Description of the Related Art

The disclosure relates to a method and an apparatus for extending bandwidth using artificial intelligence.

Conventionally, during the transmission and reception of signals through a network, bandwidth degradation in high frequencies occurs due to the use of low-quality codecs for real-time processing. Bandwidth extension (BWE) technology, which reconstructs wideband signals from narrowband signals using lossy compression, has been triggered by some streaming services. Bandwidth extension technology refers to the technique of extending bandwidth-degraded speech to a specific bandwidth to improve speech clarity. Speech clarity may be improved by recovering bandwidth degradation that occurs through network communication using bandwidth extension algorithms.

In the related arts, research has continued to improve the performance of BWE through supervised learning methods using artificial intelligence. The emergence of self-supervised learning has promoted performance improvement in combination with BWE technology. Artificial intelligence algorithm models through self-supervised learning generate better representations compared to models trained with general supervised learning, a problem occurred where the learning effect significantly decreased when the model learned different tasks sequentially.

Therefore, there is a need for a framework that does not decrease in performance even when continual learning is performed.

### SUMMARY

Provided are a method and an apparatus for extending bandwidth.

Provided are a method and an apparatus that improve the performance of bandwidth extension algorithms when performing continual learning.

According to an embodiment of the disclosure, a method performed by an electronic device using artificial intelligence, includes: receiving a first narrowband signal; and outputting a wideband signal by using the first narrowband signal as input in a pre-trained first artificial intelligence algorithm model, wherein the electronic device includes a first artificial intelligence algorithm model and a second artificial intelligence algorithm model, wherein the second artificial intelligence algorithm model is configured to output a restored narrowband signal by using a second narrowband signal as input, be trained based on the restored narrowband signal, and determine a first model parameter of the trained second artificial intelligence algorithm model, wherein the first artificial intelligence algorithm model before being pre-trained is configured to be configured with a second model parameter, and output a restored wideband signal by using the second narrowband signal as input based on the second model parameter, wherein the electronic device is configured to determine a first loss based on the restored wideband signal, determine a second loss based on the first model parameter and a fine-tuned second model parameter, pre-train the first artificial intelligence algorithm model before being pre-trained based on the first loss and the second loss, and update the first loss according to the pre-training, wherein the first artificial intelligence algorithm model before being pre-trained is continuously pre-trained, wherein the first loss is updated corresponding to the number of pre-training iterations of the first artificial intelligence algorithm model.

In an embodiment, the first artificial intelligence algorithm model may be a bandwidth extension (BWE) algorithm model, and the second artificial intelligence algorithm model may be a masked speech modeling (MSM) algorithm model.

In an embodiment, the first loss may be a loss determined in a continual learning algorithm, and the first loss may be a loss determined based on a Fisher information matrix.

In an embodiment, the first loss may be determined by the following Equation:

$${{\sum }_{j}}^{j} {( {θ}_{j}^{BWE} - {θ}_{j}^{MSM} )}^{T} {F}_{j}^{MSM \to BWE} ( {θ}_{j}^{BWE} - {θ}_{j}^{MSM} )$$

where [symbol] represents a transpose operator, Fⱼ represents the Fisher information matrix, θⱼ^{BWE} represents the second model parameter, and θ_{J}^{MSM} represents the first model parameter.

In an embodiment, the second artificial intelligence algorithm model may be configured to receive the second narrowband signal, divide it into blocks through a split process, mask the blocked second narrowband signal, and output the restored narrowband signal based on the masked blocked second narrowband signal.

In an embodiment, the first narrowband signal may be a signal generated with reduced bandwidth.

In an embodiment, the second model parameter may be fine-tuned by the first model parameter.

In an embodiment, the first loss may be determined based on a mean square error (MSE) loss of the first artificial intelligence algorithm model.

According to an embodiment of the disclosure, an electronic device includes: a memory; a modem; and a processor connected to the modem and the memory, wherein the processor is configured to: receive a first narrowband signal, and output a wideband signal by using the first narrowband signal as input in a pre-trained first artificial intelligence algorithm model, wherein the processor includes a first artificial intelligence algorithm model and a second artificial intelligence algorithm model, wherein the second artificial intelligence algorithm model is configured to output a restored narrowband signal by using a second narrowband signal as input, be trained based on the restored narrowband signal, and determine a first model parameter of the trained second artificial intelligence algorithm model, wherein the first artificial intelligence algorithm model before being pre-trained is configured to be configured with a second model parameter, and output a restored wideband signal by using the second narrowband signal as input based on the second model parameter, wherein the processor is configured to determine a first loss based on the restored wideband signal, determine a second loss based on the first model parameter and a fine-tuned second model parameter, pre-train the first artificial intelligence algorithm model before being pre-trained based on the first loss and the second loss, and update the first loss according to the pre-training, wherein the first artificial intelligence algorithm model before being pre-trained is continuously pre-trained, wherein the first loss is updated corresponding to the number of pre-training iterations of the first artificial intelligence algorithm model.

According to an embodiment of the disclosure, a program stored in a medium for extending bandwidth through an artificial intelligence algorithm executable by a processor, includes: receiving a first narrowband signal; and outputting a wideband signal by using the first narrowband signal as input in a pre-trained first artificial intelligence algorithm model, wherein the electronic device includes a first artificial intelligence algorithm model and a second artificial intelligence algorithm model, wherein the second artificial intelligence algorithm model is configured to output a restored narrowband signal by using a second narrowband signal as input, be trained based on the restored narrowband signal, and determine a first model parameter of the trained second artificial intelligence algorithm model, wherein the first artificial intelligence algorithm model before being pre-trained is configured to be configured with a second model parameter, and output a restored wideband signal by using the second narrowband signal as input based on the second model parameter, wherein the electronic device is configured to determine a first loss based on the restored wideband signal, determine a second loss based on the first model parameter and a fine-tuned second model parameter, pre-train the first artificial intelligence algorithm model before being pre-trained based on the first loss and the second loss, and update the first loss according to the pre-training, wherein the first artificial intelligence algorithm model before being pre-trained is continuously pre-trained, wherein the first loss is updated corresponding to the number of pre-training iterations of the first artificial intelligence algorithm model.

According to an embodiment of the disclosure, learning can be performed without decreasing the performance of a pre-trained artificial intelligence algorithm model when performing continual learning.

According to an embodiment of the disclosure, clarity and voice quality can be improved by effectively performing recovery for signals with degraded bandwidth.

### BRIEF DESCRIPTION OF THE DRAWINGS

Embodiments of the disclosure will be more clearly understood from the following detailed description taken in conjunction with the accompanying drawings in which:

FIG. 1 is a conceptual diagram illustrating the basic principles of an artificial intelligence structure according to an embodiment of the disclosure.

FIG. 2 is a diagram illustrating a training process of a bandwidth extension algorithm according to an embodiment of the disclosure.

FIG. 3 is a schematic diagram of a process for improving the performance of a bandwidth extension algorithm through continual learning according to an embodiment of the disclosure.

FIG. 4 is a diagram illustrating a framework of an artificial intelligence algorithm model according to a learning technique of an embodiment of the disclosure.

FIG. 5 is a block configuration diagram of an electronic device with the artificial intelligence algorithm model applied according to an embodiment of the disclosure.

FIG. 6 is a flowchart explaining the method of performing bandwidth extension according to an embodiment of the disclosure.

### DETAILED DESCRIPTION

The disclosure may be variously modified and have various embodiments, so that specific embodiments will be illustrated in the drawings and described in the detailed description. However, this does not limit the disclosure to specific embodiments, and it should be understood that the disclosure covers all the modifications, equivalents and replacements included within the idea and technical scope of the disclosure.

In explaining the disclosure, in the following description, a detailed explanation of known related technologies may be omitted to avoid unnecessarily obscuring the subject matter of the disclosure. In addition, numeral figures (for example, 1, 2, and the like) used during describing the disclosure are just identification symbols for distinguishing one element from another element.

Further, in the disclosure, if it is described that one component is “connected” or “accesses” the other component, it is understood that the one component may be directly connected to or may directly access the other component but unless explicitly described to the contrary, another component may be “connected” or “access” between the components.

In addition, terms including “unit”, “er”, “or”, “module”, and the like disclosed in the disclosure mean a unit that processes at least one function or operation and this may be implemented by hardware or software such as a processor, a microprocessor, a micro controller, a central processing unit (CPU), a graphics processing unit (GPU), an accelerated Processing unit (APU), a digital signal processor (DSP), an application specific integrated circuit (ASIC), and a field programmable gate array (FPGA) or a combination of hardware and software, this also may be implemented in a form that is combined with memory which stores data necessary for processing at least one function or operation.

Moreover, it is intended to clarify that components in the disclosure are distinguished in terms of primary functions of the components. That is, two or more components to be described below may be provided to be combined to one component or one component may be provided to be divided into two or more components for each more subdivided function. In addition, each of the respective components to be described below may additionally perform some or all functions among functions which other components take charge of in addition to a primary function which each component takes charge of and some functions among the primary functions which the respective components take charge of are exclusively charged by other components to be performed, of course.

In the description of the embodiments, certain detailed explanations of a related function or configuration are omitted when it is deemed that they may unnecessarily obscure the essence of the disclosure. In addition, the terms described below are defined in consideration of the functions in the disclosure, and may vary depending on the intention or custom of a user or an operator. Therefore, the definition needs to be made based on content throughout this specification.

For the same reason, some components may be exaggerated, omitted, or schematically shown in the accompanying drawings. In addition, the size of each component does not entirely reflect its actual size. In each drawing, identical or corresponding components are given the same reference numerals.

The advantages and features of the disclosure and a method of achieving them will become clear by referring to the embodiments described in detail below along with the accompanying drawings. However, the disclosure is not limited to the embodiments disclosed below, but may be implemented in various different forms. The embodiments are provided to ensure that the description of the disclosure is complete and to fully inform one of ordinary skill in the art of the scope of the disclosure, and the claimed scope of the disclosure is only defined by the scope of the claims.

At this time, it will be understood that each block of processing flow charts and combinations of the processing flow charts may be performed by computer program instructions. Because these computer program instructions may be mounted on a processor of a general-purpose computer, special-purpose computer, or other programmable data processing equipment, the instructions performed through the processor of the computer or other programmable data processing device creates a unit to perform functions described in flow chart block(s). These computer program instructions may also be stored in computer-usable or computer-readable memory that can be directed to a computer or other programmable data processing equipment to implement the functions in a particular manner. Accordingly, the instructions stored in the computer-usable or computer-readable memory may also produce manufactured items containing an instruction unit that performs the functions described in the flow chart block(s). Because the computer program instructions can be mounted on a computer or other programmable data processing equipment, instructions that execute a computer or other programmable data processing equipment by performing a series of operations on a computer or other programmable data processing equipment to generate a computer-executable process may also provide operations for executing the functions described in the flow chart block(s).

In addition, each block may represent a module, segment, or portion of code containing one or more executable instructions for executing specified logical function(s). In addition, in some Alternative implementations, it is possible for functions mentioned in the blocks to occur out of order. For example, two blocks shown in succession may be performed substantially simultaneously, or the blocks may sometimes be performed in reverse order depending on their corresponding functions.

The term “unit or part” used in the disclosure refers to software or hardware components such as a field-programmable gate array (FPGA) or an application specific integrated circuit (ASIC), and the “unit or part” may be configured to perform specific roles. However, the “unit or part” is not limited to software or hardware. The “unit or part” may be configured to be stored in an addressable storing medium or to execute one or more processors. Accordingly, the “unit or part” may include, for example, software components, object-oriented software components, components such as class components and task components, processors, formulas, attributes, procedures, subroutines, segments of program code, drivers, firmware, micro code, circuits, data, database, data structures, tables, arrays and variables. Functions provided in components and “units or parts” may be combined into a smaller number of components and “units or parts”, or may be further divided into additional components and “units or parts.” Furthermore, components and “units or parts” may be implemented to reproduce one or more central processing units within a device or a secure multimedia card. In addition, in an embodiment, “unit or part” may include one or more processors and/or devices.

Hereinafter, embodiments according to the inventive concept of the disclosure will be described in detail in order.

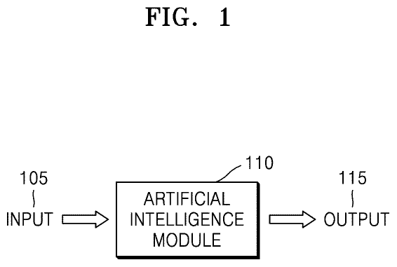

FIG. 1 is a conceptual diagram illustrating the basic principles of an artificial intelligence structure according to an embodiment of the disclosure.

Referring to FIG. 1, FIG. 1 shows the basic principles by which training is performed in an artificial intelligence structure.

Artificial intelligence technology refers to technology for solving cognitive problems primarily associated with human intelligence, such as learning, problem-solving, and recognition. Artificial intelligence can be trained through machine learning (ML) and deep learning (DL) methods. Machine learning is mainly used in techniques for pattern recognition and learning, and refers to algorithms that learn from recorded data to predict subsequent data based on a result of the learning. Alternatively, machine learning refers to a technology that learns by itself from data without being based on predefined rules or patterns. In contrast, Deep Learning is a field of machine learning that has a difference in processing data based on Artificial Neural Networks (ANN). Because deep learning uses artificial neural networks, deep learning can process more complex and sophisticated computations than machine learning. Types of algorithms for deep learning may include Convolutional Neural Networks (CNN), Artificial Neural Networks (ANN), and Recurrent Neural Networks (RNN).

Referring to FIG. 1, the artificial intelligence structure may be represented as an artificial intelligence module 110. The artificial intelligence module 110 receives predetermined input data 105, performs learning through a predetermined method defined in the module, and outputs output data 115 for the learning results. According to an embodiment, the input data 105 may include predetermined data, voice signals, input sequences, bandwidth-degraded voice, etc. The output data 115 may include bandwidth-extended voice signals, high-frequency voice signals, output sequences, etc.

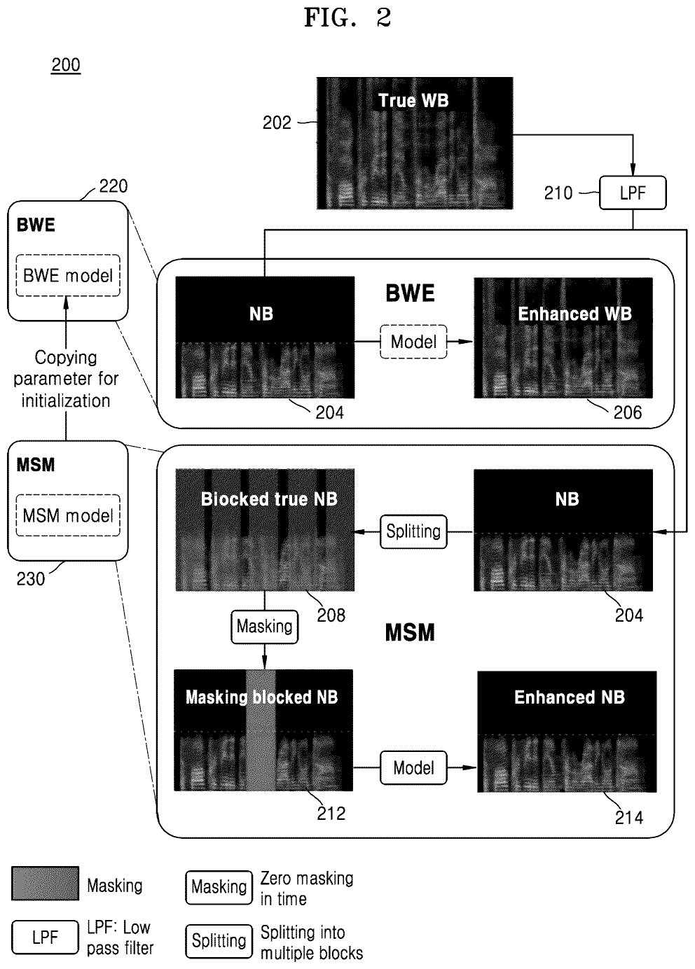

FIG. 2 is a diagram illustrating a training process of a bandwidth extension algorithm according to an embodiment of the disclosure.

The artificial intelligence algorithm model 200 of FIG. 2 may be one of the types of the artificial intelligence module 110 of FIG. 1. According to an embodiment, the artificial intelligence algorithm model 200 of FIG. 2 may include a TUNet (transformer-aided Unet) model. TUNet may represent an audio super-resolution model based on a waveform-to-waveform structure. The artificial intelligence algorithm model 200 may include an architecture with a low-complexity transformer encoder in bottleneck components to effectively capture global dependencies while maintaining a small model size. The artificial intelligence algorithm model 200, as a base model, may be trained during pre-training and fine-tuning in a manner according to the following Equation 1.

$${L}_{R} = {L}_{MR} + α {L}_{MSE} \qquad [ Equation 1 ]$$

Here, L_{R} represents a reconstruction loss, L_{MR} represents a multi-resolution short-time Fourier transform (STFT) loss, L_{MSE} represents a mean square error (MSE) loss, and a may represent a weight of the MSE loss.

Referring to FIG. 2, the artificial intelligence algorithm model 200 may include a BWE module 220 and an MSM (masked speech modeling) module 230. The MSM module 230 may apply self-supervised pre-training techniques. Speech signals may be applied to the MSM module 230, and the model parameter may be fine-tuned to match a target task of the BWE module 220.

First, when an original wideband signal 202 is received, a narrowband signal 204, which is a bandwidth-degraded signal, may be generated through a filter 210 (for example, a low pass filter: LPF). The narrowband signal may be input to both the BWE module 220 and the MSM module 230.

In the MSM module 230, the narrowband signal 204 may be split into block units through a splitting process to generate a narrowband signal 208. The narrowband signal 208 split into block units (hereinafter, blocked narrowband signal) may become a masked narrowband signal 212 split into block units (hereinafter, masked blocked narrowband signal) through a masking process. The masked blocked narrowband signal may be used as input to a model of the MSM module 230 and output as a restored narrowband signal 214, the model may be trained while updating the model parameters. Consequently, the parameter of the pre-trained MSM model may be copied to the BWE module 220 for initialization. The BWE module 220 may be trained to output a restored wideband signal 206 using the narrowband signal 204 as input based on the copied model parameter.

The continual learning (CL) described in the disclosure may represent machine learning that allows a model to adapt to changes in data distribution by performing continual learning from new data without losing knowledge of previous tasks.

Hereinafter, the disclosure proposes a framework that integrates MSM pre-training and BWE fine-tuning through the continual learning approach for enhanced super-resolution performance regarding the artificial intelligence algorithm model 200 of FIG. 2.

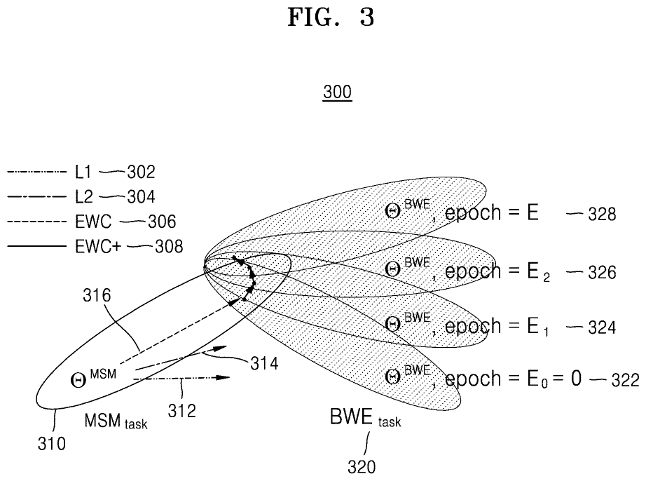

FIG. 3 is a schematic diagram of a process for improving the performance of a bandwidth extension algorithm through continual learning according to an embodiment of the disclosure.

FIG. 3 may be interpreted as showing how performance improves through angles according to the continual learning in the artificial intelligence algorithm model described in the disclosure. The artificial intelligence algorithm model in FIG. 3 may be trained in a manner that performs continual learning from MSM pre-training to BWE fine-tuning. For example, the framework of the model may be referred to as CLASS (continual learning approach for speech super-resolution) framework (hereinafter CLASS).

In the CLASS of FIG. 3, task K is fixed and there is no change in the dataset, so K and d are omitted to simplify the problem. In the CLASS, when retraining for BWE, the continual learning may be applied to the algorithm through a loss as shown in Equation 2.

$${L}_{total} = {L}_{R} + λ {L}_{CL} \qquad [ Equation 2 ]$$

Here, Lₜₒₜₐₗ is a training objective applied when performing fine-tuning learning of the artificial intelligence algorithm model pre-trained with MSM, L_{CL} represents the continual learning loss, and λ is a hyperparameter to control the weight of L_{CL}. Here, the continual learning loss may be expressed as L₁₁, L₁₂, which may represent transfer losses of L1 and L2, respectively. Here, 11 and 12 may represent a distance between model parameters.

After pre-training the model using LR as described in FIG. 2, a pre-trained model parameter Θ_{J}^{MSM} showing the best performance may be obtained. Sequentially, the CLASS may continuously fine-tune the pre-trained model for the BWE task using data D. Finally, Θ_{J}^{BWE} which is a fine-tuned BWE model parameter of length J, may be derived. By using the continual learning approach, the model knowledge for training to predict masked inputs in the MSM may be maintained, furthermore the BWE may be used as a downstream task.

The previously described training losses represented as L₁₁, L₁₂ are as follows.

$${L}_{i 1} = {‖ {Θ}_{j}^{BWE} - {Θ}_{j}^{MSM} ‖}_{1}^{1} \qquad [ Equation 3 ]$$

$${L}_{i 2} = {‖ {Θ}_{j}^{BWE} - {Θ}_{j}^{MSM} ‖}_{2}^{2} \qquad [ Equation 4 ]$$

Here, Equation 3 may represent updating the BWE model parameter by parameterizing with the L1 norm of the MSM model parameter. Similarly, Equation 4 may represent updating the BWE model parameter by parameterizing with the L2 norm of the MSM model parameter.

Next, EWC (elastic weight consolidation) may determine the loss by utilizing importance weights. Here, the importance weights may correspond to a diagonal of the FIM (Fisher information matrix) for the target's log likelihood. In the case of the CLASS, the log likelihood function may be replaced with cross entropy (CE) loss. The EWC loss may be determined according to the following equation.

$${L}_{EWC} = {{\sum }_{j}}^{J} {( {θ}_{j}^{BWE} - {θ}_{j}^{MSM} )}^{T} {F}_{j} ( {θ}_{j}^{BWE} - {θ}_{j}^{MSM} ) \qquad [ Equation 5 ]$$

Here, [symbol] represents a transpose operator, and Fⱼ is the Fisher information matrix, which may be calculated as shown in the following Equation 6.

$${F}_{j} = {𝔼}_{x \sim π} \{ {𝔼}_{y \sim p ( y \vert x ; {θ}_{j} )} [ ( \frac{\partial log p}{\partial {θ}_{j}} ) {( \frac{\partial log p}{\partial {θ}_{j}} )}^{T} ] \} \qquad [ Equation 6 ]$$

Here, π may represent an empirical distribution of the training set X^{BWE}. The EWC method may effectively calculate L_{CL} by using Fⱼ to calculate the distance between the BWE model parameter and the pre-trained model parameter.

In the CLASS, the BWE model performs well in the BWE based on knowledge about the MSM which may be confirmed. However, compared to the static MSM model, the BWE model has been fine-tuned according to the BWE task. Therefore, instead of maintaining the MSM model without changes, a method of updating the MSM model using the BWE model was utilized. Such an update method may be accompanied by loss of historical information. To solve this problem, an exponential moving average (EMA) method may be utilized. The EMA is a method used in the student-teacher learning framework that gradually updates the teacher model based on the teacher model parameters and student model parameters. The EMA method may be applied to conventional continual learning algorithms as shown in the following Equation 7.

$${Θ}_{j , i}^{EMA} = \{ \begin{matrix}{Θ}_{j , i}^{MSM} , if i = 0 \\ m {Θ}_{j , i - 1}^{EMA} + ( 1 - m ) {Θ}_{j , i}^{EWE} , otherwise\end{matrix} \qquad [ Equation 7 ]$$

Here, Θ_{j,i}^{EMA} represents a MSM_{EMA} model parameter that serves as the teacher model parameter, and Θ_{j,i}^{BWE} may represent a BWE model parameter. A resulting value Θ_{J,1}^{MSN} may represent the pre-trained MSM model parameter. m is a momentum factor that may have a range between 0 and 1.

The EWC method based on previous MSM knowledge showed good performance in the BWE task. However, using static importance weights derived from the MSM pre-training phase may cause limitations for the deep learning model when performing fine-tuning for the BWE.

Therefore, a new EWC+ method is proposed for updating Fⱼ^{MSM} during training in the BWE fine-tuning phase.

$${L}_{EWC +} = {{\sum }_{j}}^{j} {( {θ}_{j}^{BWE} - {θ}_{j}^{MSM} )}^{T} {F}_{j}^{MSM \to BWE} ( {θ}_{j}^{BWE} - {θ}_{j}^{MSM} ) \qquad [ Equation 8 ]$$

When calculating the conventional EWC loss, the Fisher information matrix is calculated only once, whereas in Equation 8, the Fisher information matrix is updated multiple times as F₁^{MSM→BWE}, potentially maximizing the training effect of BWE while maintaining the effect of MSM pre-training. In the EWC+ method, at an initial point of the BWE fine-tuning phase, L^{EWC} may be calculated using the importance weights of the Fisher information matrix, which holds information from the previous MSM task. After repeated epoch training, as the BWE model parameter is updated, F_{J}^{MSM→BWE} may be derived through accurate calculation of the log likelihood. FIG. 3 conceptually represents this approach.

Referring to FIG. 3, the direction 310 that indicates when the performance of the MSM model is most effective (hereinafter, the performance direction) may be identified. Specifically, when MSM model is trained based on L1 loss 302, direction 312 in the MSM model parameter shows the greatest difference from the performance direction 310, and when MSM model is trained based on L2 loss 304, direction 314 is more effective than L1 loss but still differs from the performance direction 310. When learning using the EWC loss 306, it may be confirmed that the model progresses in a direction consistent with the performance direction 310. That is, it may be schematically confirmed that the task performance of the MSM model when utilizing the EWC loss is most effective.

However, when additional training is applied using the BWE model after training with EWC loss in the MSM model's task, it may be confirmed that the direction becomes misaligned again, as in BWE learning 322. That is, a sharp decrease in performance may be observed. To solve this problem, the EWC+ method 308 may be applied. The EWC+ method 308 utilizes continual learning for BWE training. After the first BWE training 322, if the training proceeds one more time, it can be confirmed that performance improves with the second BWE training 324, and as the third BWE training 326 and fourth BWE training 328 proceed additionally, it can be confirmed that the performance direction of the BWE task becomes almost similar to the performance direction 310 of the initial MSM model's task. That is, through continual learning, the performance of the BWE task after the MSM task may be improved.

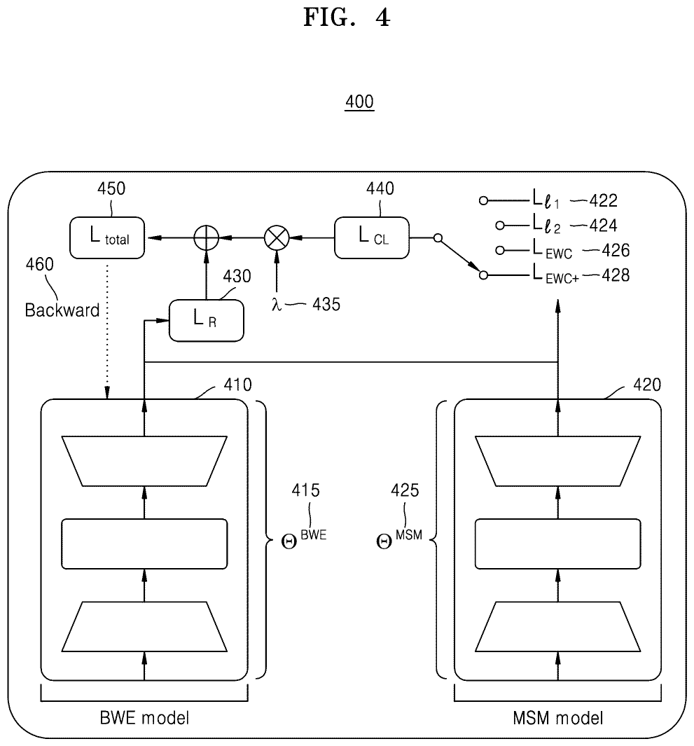

FIG. 4 is a diagram illustrating a framework of an artificial intelligence algorithm model according to a learning technique of an embodiment of the disclosure.

A BWE model 410 and an MSM model 420 of FIG. 4 may be identical or similar to the BWE model 220 and the MSM model 230 of FIG. 2 to 3. The losses 422, 424, 426, 428 according to the learning technique of FIG. 4 may be identical to the losses 302, 304, 306, 308 according to the learning technique of FIG. 3. FIG. 4 may represent the learning process of FIG. 3 in the form of a block diagram.

Referring to FIG. 4, the artificial intelligence algorithm model 400 may include the BWE model 410 and the MSM model 420. In the artificial intelligence algorithm model 400, the MSM model 420 may be pre-trained, and the training of the BWE model 410 may be performed based on the pre-training of the MSM model 420. The artificial intelligence algorithm model 400 may perform overall training based on Lₜₒₜₐₗ 450. Lₜₒₜₐₗ 450 may be determined as the sum of the reconstruction loss (L_{R}) 430 and the continual learning loss (L_{CL}) 440 multiplied by a weight λ 435, as explained in Equation 2 in FIG. 2. Through Lₜₒₜₐₗ 450, the BWE model 410 may be trained via backward propagation 460. Here, L_{CL} 440 is a training objective of the continual learning algorithm and may be selectively determined through existing algorithms such as L1 loss (L₁₁) 422, L2 loss (L₁₂) 424, EWC loss 426, and the newly proposed EWC+ loss 428. Each of these losses is determined from the tasks of the MSM model 420, where the MSM model parameter 425 may be updated by the BWE model parameter 415.

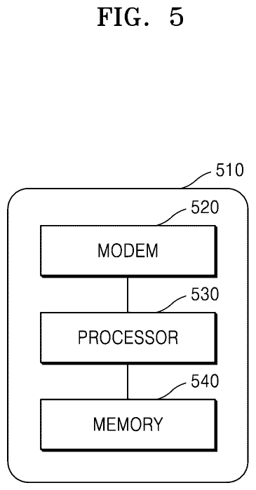

FIG. 5 is a block configuration diagram of an electronic device with the artificial intelligence algorithm model applied according to an embodiment of the disclosure.

Referring to FIG. 5, the electronic device 510 may include a modem 520, a memory 540, and a processor 530.

The modem 520 may be a communication modem that is electrically connected to other electronic devices to enable mutual communication. In particular, the modem 520 may receive data input and transmit it to the processor 530, and the processor 530 may be configured to store the input data value in the memory 540. In addition, the information output by the trained artificial intelligence algorithm in the system may be transmitted to other electronic devices.

The memory 540 is a component where various information and program instructions for the process of the electronic device 510 are stored, and may be a storage device such as a hard disk, solid state drive (SSD), etc. In particular, the memory 540 may store one or more data input values from the modem 520 under the control of the processor 530. Furthermore, the memory 540 may store program instructions executable by the processor 530, such as artificial intelligence algorithms for bandwidth extension.

The processor 530 is composed of at least one processor and may use the data and program instructions stored in the memory 540 to calculate data using bandwidth extension artificial intelligence algorithms and bandwidth extension artificial intelligence algorithms learned through the CLASS method. The processor 530 may control and compute all artificial intelligence algorithm models explained in FIG. 1 to FIG. 4 (for example, bandwidth extension algorithm model, MSM model, BWE model, TUNet model, artificial intelligence algorithm model trained through the CLASS method).

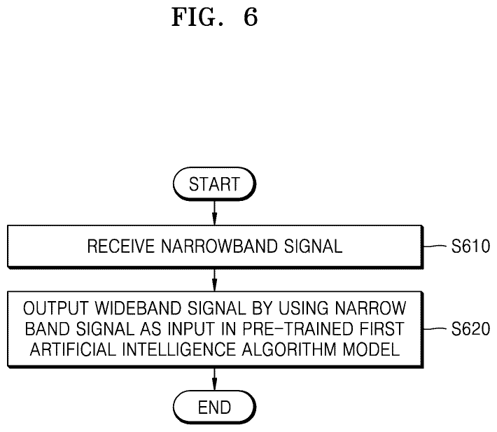

FIG. 6 is a flowchart explaining the method of performing bandwidth extension according to an embodiment of the disclosure.

Referring to FIG. 6 below, a summary of the training process of the artificial intelligence algorithm, the bandwidth expansion method, and the method of training the artificial intelligence algorithm through the CLASS method, which are explained with reference to FIG. 1 to FIG. 5, will be described. Each process is not necessarily required to be included in a series of processes and may be configured and operated partially depending on the situation.

In step S610, the electronic device may receive a first narrowband signal (for example, the narrowband signal 204 in FIG. 2). In one embodiment, the first narrowband signal may be a signal generated when a wideband signal (for example, the original signal 202 in FIG. 2) has its bandwidth degraded during communication.

In step S620, the electronic device may output a wideband signal (for example, the restored wideband signal 206 in FIG. 2) by using the first narrowband signal as input in a pre-trained first artificial intelligence algorithm model (for example, the BWE module 220 in FIG. 2, the BWE model 410 in FIG. 4).

According to an embodiment, the electronic device may include a first artificial intelligence algorithm model (which may include both after pre-training and before pre-training) and a second artificial intelligence algorithm model (for example, the MSM module 230 in FIG. 2, the MSM model 420 in FIG. 4). The second artificial intelligence algorithm model may be configured to output a restored narrowband signal (for example, the restored narrowband signal 214 in FIG. 2) by using a second narrowband signal (for example, the narrowband signal 204 in FIG. 2) as input, be trained based on the restored narrowband signal, and determine a first model parameter (for example, the MSM model parameter 425 in FIG. 4) of the trained second artificial intelligence algorithm model.

According to an embodiment, the first artificial intelligence algorithm model before pre-training may be configured with a second model parameter (for example, the BWE model parameter 415 in FIG. 4), and configured to output a restored wideband signal (for example, the restored wideband signal 206 in FIG. 2) by using the second narrowband signal as input based on the second model parameter.

According to an embodiment, the electronic device may be configured to determine a first loss (for example, the reconstruction loss 430 in FIG. 4) based on the restored wideband signal, determine a second loss (for example, the continual learning loss 440 in FIG. 4) based on the first model parameter and a fine-tuned second model parameter, pre-train the first artificial intelligence algorithm model before being pre-trained based on the first loss and the second loss, and update the first loss according to the pre-training.

According to an embodiment, the first artificial intelligence algorithm model before being pre-trained may be continuously pre-trained.

According to an embodiment, the first loss may be updated corresponding to the number of pre-training iterations of the first artificial intelligence algorithm model.

According to an embodiment, the first artificial intelligence algorithm model may be a bandwidth extension (BWE) algorithm model, and the second artificial intelligence algorithm model may be a masked speech modeling (MSM) algorithm model.

According to an embodiment, the first loss is a loss determined in a continual learning algorithm, and the first loss is a loss determined based on the Fisher information matrix.

According to an embodiment, the second artificial intelligence algorithm model may be configured to receive the second narrowband signal, divide the second narrowband signal into blocks through a split process, mask the blocked second narrowband signal (for example, the blocked narrowband signal 208 in FIG. 2), and output the restored narrowband signal based on the masked blocked second narrowband signal (for example, the masked blocked narrowband signal 212 in FIG. 2).

According to an embodiment, the second model parameter may be fine-tuned by the first model parameter.

According to an embodiment, the first loss may be determined based on a mean square error (MSE) loss of the first artificial intelligence algorithm model.

Although the inventive concept of the disclosure is described in detail with numerous embodiments, the inventive concept of the disclosure is not limited to the above embodiments, and various modifications and alterations are possible by those skilled in the art within the scope of the inventive concept of the disclosure.

What is claimed is:

1. A method performed by an electronic device using artificial intelligence, comprising:
receiving a first narrowband signal; and
outputting a wideband signal by using the first narrowband signal as input in a pre-trained first artificial intelligence algorithm model,
wherein the electronic device includes a first artificial intelligence algorithm model and a second artificial intelligence algorithm model,
wherein the second artificial intelligence algorithm model is configured to output a restored narrowband signal by using a second narrowband signal as input, be trained based on the restored narrowband signal, and determine a first model parameter of the trained second artificial intelligence algorithm model,
wherein the first artificial intelligence algorithm model before being pre-trained is configured to be configured with a second model parameter, and output a restored wideband signal by using the second narrowband signal as input based on the second model parameter,
wherein the electronic device is configured to determine a first loss based on the restored wideband signal, determine a second loss based on the first model parameter and a fine-tuned second model parameter, pre-train the first artificial intelligence algorithm model before being pre-trained based on the first loss and the second loss, and update the first loss according to the pre-training,
wherein the first artificial intelligence algorithm model before being pre-trained is continuously pre-trained,
wherein the first loss is updated corresponding to the number of pre-training iterations of the first artificial intelligence algorithm model.

2. The method of claim 1, wherein the first artificial intelligence algorithm model is a bandwidth extension (BWE) algorithm model,
wherein the second artificial intelligence algorithm model is a masked speech modeling (MSM) algorithm model.

3. The method of claim 1, wherein the first loss is a loss determined in a continual learning algorithm,
wherein the first loss is a loss determined based on a Fisher information matrix.

4. The method of claim 3, wherein the first loss is determined by the following Equation:
$${{\sum }_{j}}^{j} {( {θ}_{j}^{BWE} - {θ}_{j}^{MSM} )}^{T} {F}_{j}^{MSM \to BWE} ( {θ}_{j}^{BWE} - {θ}_{j}^{MSM} )$$
wherein [symbol] represents a transpose operator, Fⱼ represents the Fisher information matrix, Θⱼ^{BWE} represents the second model parameter, and Θⱼ^{MSM} represents the first model parameter.

5. The method of claim 1, wherein the second artificial intelligence algorithm model is configured to:
receive the second narrowband signal, divide the second narrowband signal into blocks through a split process, mask the blocked second narrowband signal, and output the restored narrowband signal based on the masked blocked second narrowband signal.

6. The method of claim 1, wherein the first narrowband signal is a signal generated with reduced bandwidth.

7. The method of claim 1, wherein the second model parameter is fine-tuned by the first model parameter.

8. The method of claim 1, wherein the first loss is determined based on a mean square error (MSE) loss of the first artificial intelligence algorithm model.

9. An electronic device, comprising:
a memory;
a modem; and
a processor connected to the modem and the memory,
wherein the processor is configured to:
receive a first narrowband signal, and
output a wideband signal by using the first narrowband signal as input in a pre-trained first artificial intelligence algorithm model,
wherein the processor includes a first artificial intelligence algorithm model and a second artificial intelligence algorithm model,
wherein the second artificial intelligence algorithm model is configured to output a restored narrowband signal by using a second narrowband signal as input, be trained based on the restored narrowband signal, and determine a first model parameter of the trained second artificial intelligence algorithm model,
wherein the first artificial intelligence algorithm model before being pre-trained is configured to be configured with a second model parameter, and output a restored wideband signal by using the second narrowband signal as input based on the second model parameter,
wherein the processor is configured to determine a first loss based on the restored wideband signal, determine a second loss based on the first model parameter and a fine-tuned second model parameter, pre-train the first artificial intelligence algorithm model before being pre-trained based on the first loss and the second loss, and update the first loss according to the pre-training,
wherein the first artificial intelligence algorithm model before being pre-trained is continuously pre-trained,
wherein the first loss is updated corresponding to the number of pre-training iterations of the first artificial intelligence algorithm model.

10. The electronic device of claim 9, wherein the first artificial intelligence algorithm model is a bandwidth extension (BWE) algorithm model,
wherein the second artificial intelligence algorithm model is a masked speech modeling (MSM) algorithm model.

11. The electronic device of claim 9, wherein the first loss is a loss determined in a continual learning algorithm,
wherein the first loss is a loss determined based on a Fisher information matrix.

12. The electronic device of claim 11, wherein the first loss is determined by the following Equation:
$${{\sum }_{j}}^{j} {( {θ}_{j}^{BWE} - {θ}_{j}^{MSM} )}^{T} {F}_{j}^{MSM \to BWE} ( {θ}_{j}^{BWE} - {θ}_{j}^{MSM} )$$
wherein, [symbol] represents a transpose operator, Fⱼ represents the Fisher information matrix, Θⱼ^{BWE} represents the second model parameter, and Θⱼ^{MSM} represents the first model parameter.

13. The electronic device of claim 9, wherein the second artificial intelligence algorithm model is configured to:
receive the second narrowband signal, divide the second narrowband signal into blocks through a split process, mask the blocked second narrowband signal, and output the restored narrowband signal based on the masked blocked second narrowband signal.

14. The electronic device of claim 9, wherein the first narrowband signal is a signal generated with reduced bandwidth.

15. The electronic device of claim 9, wherein the second model parameter is fine-tuned by the first model parameter.

16. The electronic device of claim 9, wherein the first loss is determined based on a mean square error (MSE) loss of the first artificial intelligence algorithm model.

17. A program stored in a medium for extending bandwidth through an artificial intelligence algorithm executable by a processor, comprising:
receiving a first narrowband signal; and
outputting a wideband signal by using the first narrowband signal as input in a pre-trained first artificial intelligence algorithm model,
wherein the electronic device includes a first artificial intelligence algorithm model and a second artificial intelligence algorithm model,
wherein the second artificial intelligence algorithm model is configured to output a restored narrowband signal by using a second narrowband signal as input, be trained based on the restored narrowband signal, and determine a first model parameter of the trained second artificial intelligence algorithm model,
wherein the first artificial intelligence algorithm model before being pre-trained is configured to be configured with a second model parameter, and output a restored wideband signal by using the second narrowband signal as input based on the second model parameter,
wherein the electronic device is configured to determine a first loss based on the restored wideband signal, determine a second loss based on the first model parameter and a fine-tuned second model parameter, pre-train the first artificial intelligence algorithm model before being pre-trained based on the first loss and the second loss, and update the first loss according to the pre-training,
wherein the first artificial intelligence algorithm model before pre-training is continuously pre-trained,
wherein the first loss is updated corresponding to the number of pre-training iterations of the first artificial intelligence algorithm model.
